(19) United States
(12) Patent Application Publication
(10) Pub. No.: US 2020/0311521 A1
(43) Pub. Date: Oct. 1, 2020

(54) LOOP-BASED EXECUTION FOR EFFICIENT DEEP LEARNING

(71) Applicant: Vathys, Inc., Portland, OR (US)

(72) Inventor: Tapabrata Ghosh, Portland, OR (US)

(21) Appl. No.: 16/365,460

(22) Filed: Mar. 26, 2019

(51) Int. Cl. G06N 3/06; G06F 9/38; G06F 9/30; G06F 9/50; G06F 17/16

(52) U.S. Cl. CPC G06N 3/06; G06F 9/38; G06F 17/16; G06F 9/505; G06F 9/30134

(57) ABSTRACT

Disclosed are systems and methods for increasing performance of parallel execution and conserving hardware resources by detecting performance saving data elements and applying performance improving measures. Machine learning accelerators are disclosed that utilize parallelism in data while taking advantage of performance saving data elements to improve performance of machine learning parallel execution.

### BACKGROUND

### Field of the Invention

This invention relates generally to the field of hardware accelerators and more particularly to hardware accelerators for improving performance and efficiency of machine learning processors for handling deep learning data.

### Description of the Related Art

High degree of parallelism present in machine learning computations and data structures presents an excellent opportunity for improving performance of systems that execute machine learning operations. Nonetheless, hardware resources available to dedicate to parallel operations are limited. Therefore, there is a need for systems and methods that utilize parallelism in machine learning workloads while conserving hardware resources.

### SUMMARY

In one aspect of the invention, a method of parallel execution in a machine learning accelerator is disclosed. The method includes: receiving and/or determining an operation to be cast on a data structure of a machine learning workload; determining a degree of parallelism in execution, wherein the degree of parallelism in execution is less than the degree of parallelism in the machine learning workload; scanning data elements of the machine learning workload; identifying performance saving data elements in the data structure; and iteratively executing the operation on the data structure, wherein each iteration comprises, executing the operation, in parallel, in the degree of parallelism in execution, on one or more data elements of the data structure if the data elements are not performance saving data elements and applying a performance saving rule if the data elements are performance saving data elements.

In one embodiment, the method further includes allocating computation units in a number equal to the degree of parallelism in execution.

In some embodiments, the performance rule is at least partly based on the operation and the value of the performance saving data element.

In another embodiment, the degree of parallelism in the machine learning workload is the degree of intra-structure parallelism in the machine learning workload.

In one embodiment, the performance rule comprises skipping the operation for performance saving data elements.

In some embodiments, the performance rule comprises one or more of treating values below a minimum threshold as zero, computing outliers with higher precision than other values, and performing multiplication of values of powers of two by register shifting.

In one embodiment, the performance saving data elements comprise one or more of zeros, small values, powers of two and outliers.

In one embodiment, determining the degree of parallelism in execution is additionally based on one or more of the operation and type of data structure.

In one embodiment, the data structure comprises one or more of vector, matrix, array and tensor.

In some embodiments, identifying performance saving data elements comprise using transistor gates for determining multiplication by zero.

In one embodiment, the method further includes pre-fetching non-performance saving data elements before their turn for execution.

In one embodiment, the operation comprises vector element-wise multiplication, vector scalar multiplication, dot product, general matrix multiplication (GEMM), generalized matrix-vector multiplication (GEMV), vector addition, or matrix addition.

In another aspect of the invention, a deep neural network learning accelerator is disclosed. The accelerator includes: a memory unit configured to receive a deep neural network workload, wherein the workload comprises a data structure and a data structure operation to be cast on the data structure; a plurality of neural network computation units capable of executing in parallel; a parallelism decision module, configured to determine a degree of parallelism in execution, wherein the degree of parallelism in execution is less than degree of parallelism in the data structure; a performance saving detector, configured to identify performance saving data elements in the data structure; and a performance controller, configured to iteratively execute the operation on the data structure, wherein each iteration comprises, executing the operation in parallel, in the degree of parallelism in execution determined by the parallelism decision module, on one or more data elements of the data structure if the data elements are not performance saving and apply a performance rule to the performance saving data elements.

In one embodiment, the performance rule comprises skipping the operation for the performance saving data elements.

In another embodiment, the degree of parallelism in the data structure is the degree of intra-structure parallelism in the data structure.

In one embodiment, the performance saving data elements comprise one or more of zeros, small values, powers of two and outliers.

In some embodiments, the parallelism decision module determines the degree of parallelism in execution additionally based on one or more of type of workload, the operation, and the data structure.

In one embodiment, the performance rule comprises one or more of treating values below a minimum threshold as zero, computing outliers with higher precision than other values, and performing multiplication of values of powers of two by register shifting

In some embodiments, the accelerator further includes a lookahead engine configured to scan future values slated for execution and identify performance saving data elements in advance of their execution.

In one embodiment, the lookahead engine is further configured to pre-fetch non-performance saving data elements for execution.

### BRIEF DESCRIPTION OF THE DRAWINGS

These drawings and the associated description herein are provided to illustrate specific embodiments of the invention and are not intended to be limiting.

FIG. 1 illustrates example data structures and operations that may be present in a machine learning workload.

FIG. 2 illustrates an example machine workload computation, which can be efficiently executed by employing the described embodiments.

FIG. 3 illustrates a block diagram of a machine learning accelerator, which can be used to detect, track, predict or otherwise identify performance saving data elements and take performance saving measures.

FIG. 4 illustrates another example machine learning operation workload that can be executed with the embodiment of FIG. 3.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

### Definitions

The term “data structure” refers to any data object of any size, dimension, type and scale, including vector, matrix, n-dimensional array and tensor structures.

The term “structural operations” refers to any operation upon one or more data structures. Examples include vector element-wise multiplication, vector scalar multiplication, dot product, general matrix multiplication (GEMINI), generalized matrix-vector multiplication (GEMV), vector addition, matrix addition, and other data structure operations.

Machine learning operations including deep learning neural network operations can be performed more efficiently by exploiting the parallelism inherent in such operations and the data structures upon which these operations are cast. In fact, often extraordinary degrees of parallelism in the order of millions exist in machine learning operations and data structures. As a result, parallelism is so plentiful that the primary limitation to the exploitation of parallelism is not the available intrinsic parallelism in the workload, rather the local computational resources available to execute parallel operations. For example, to fully exploit 100 million degrees of parallelism in a portion of a machine learning workload, hardware resources such as 100 million arithmetic logic units (ALUs) and long wires are needed. Besides the volume of hardware resources needed to fully exploit parallelism in machine learning operations and data structures, other hardware limitations, such as data path inefficiency and long wire resistance, also become considerable issues when attempting to exploit parallelism.

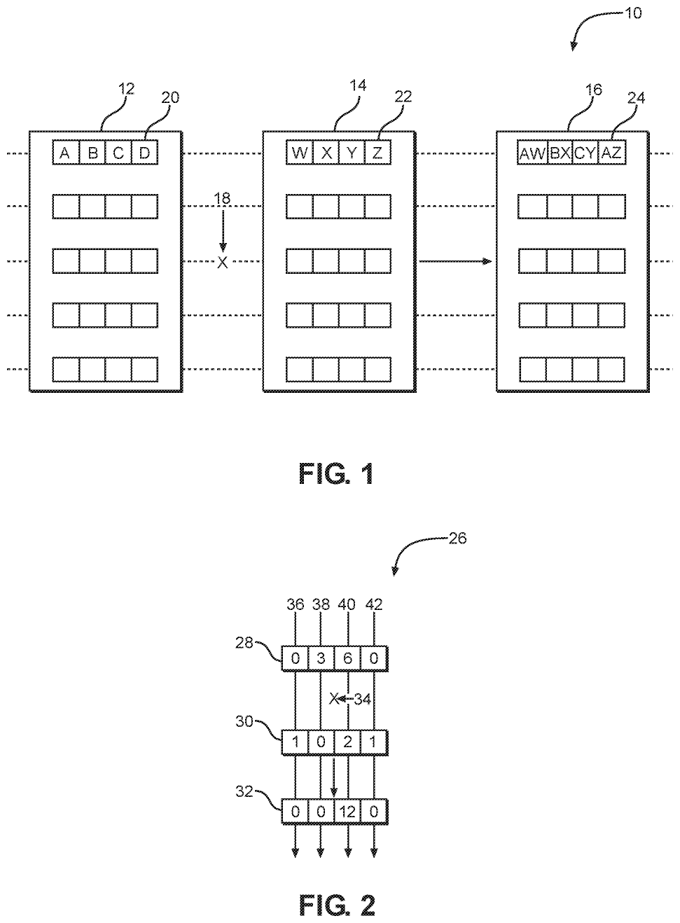

Data structures in workloads of machine learning operations can present inter-structure parallelism and intra-structure parallelism, both of which can be used to create efficiencies when performing machine learning operations. FIG. 1 illustrates example data structures and operations that maybe present in a machine learning workload 10. Machine learning workload 10 can include two datasets 12 and 14 each containing six data structures of four-element vectors. Machine learning operation 18 may be a structural operation, such as an element-wise vector multiplication, used to generate a dataset 16 containing six four-element vectors, where each four-element vector is generated from element-wise vector multiplication of the datasets 12 and 14. For example, dataset 12 can contain a four-element vector 20 of binary values (a, b, c, d), dataset 14 can contain a four element vector 22 of binary values (w, x, y, z) and dataset 16 can be generated to include a four-element vector 24 of binary values generated from element-wise vector multiplication of datasets 12 and 14. The resulting four-element vector 24 has binary values (aw, bx, cy, dz).

One intra-structure parallelism presented in workload 10 is of the fourth degree because the data structures in datasets 12, 14 and 16 are four-element vectors. By employing four ALUs in parallel, the hardware executing workload 10 can perform vector element-wise multiplications (a times w), (b times x), (c times y) and (d times z) in parallel. The workload 10 also presents an inter-structure parallelism of the sixth degree because there are six data structures in each dataset 12 and 14 upon which operation 18 is performed and such inter-parallelism can also be used to increase efficiency of the workload 10 by employing ALUs and/or other neural network computational units to perform operations related to them in parallel.

Although some systems utilize inter-structure parallelism, many current central processing units (CPUs) and/or hardware specialized for executing machine learning operations parallelize using techniques that primarily exploit intra-structure parallelism and therefore require numerous hardware intensive computing units, such as ALUs, to execute each structural operation. Example systems utilizing parallelism include single instruction multiple data (SIMD) CPUs, single instruction multiple thread (SIMT) CPUs and others. Examples of systems utilizing numerous computing units to exploit parallelism include tensor processing unit (TPU)'s matrix multiply unit, NVIDIA® Volta's graphical processing unit (GPU)'s tensor cores and Volta GPUs's SIMT vector lanes.

Additionally, data structures and workloads of machine learning operations contain data sparsity, zero values, small values, redundancies, negligible values, outliers, powers of two, and otherwise performance saving data elements which can be exploited to increase the efficiency of the hardware and/or software executing machine learning operations. Such performance saving data elements can appear in various layers of a machine learning operation, in neural network activation function layers, in weights and gradient statistics and/or other operations involving deep learning, neural network, machine learning or similar and/or other artificial intelligence (AI) operations.

Techniques exist to take advantage of performance saving data elements. For example, rectifier linear units (ReLUs) create high sparsity data structures, and some techniques, such as CNVLUTIN and SCNN, have attempted to exploit the sparsity in ReLUs and other AI workload. However, the overhead and complexity associated with existing techniques remain high. In some cases, existing techniques attempting to utilize sparsity, work in situations where sparsity in data is very high, while typical neural network workloads may not offer the high sparsity required by these techniques. For example, one GPU uses a sparse kernel (a set of computing instructions directed to handling sparse elements), but the sparse kernel is not efficient until a sparsity of above 90% can be seen in the input data. Typical neural network workloads; however, do not offer such high sparsity. Performance of hardware implementing such techniques may be limited in part due to the hardware having to use wide SIMD/vector ALUs and indices to indicate, track and treat sparse data elements.

Many existing systems generally resort to using relatively general-purpose kernels for exploiting sparsity, which can involve complex and high overhead techniques (e.g., using indexing) for detecting and handling sparsity causing these techniques to be ultimately less efficient than suggested. SCNNs use Cartesian products (a high overhead technique relative to direct operations) and indexing to skip sparse values causing a complex and ultimately less efficient system. CNVLUTIN systems take advantage of sparsity by allowing independent operations of SIMD lanes, which has high overhead and complexity leading to a less efficient system than theory suggests.

By contrast, the described techniques and embodiments offer machine learning hardware accelerators and/or software modules that can take advantage of the nature of the performance saving data elements and increase performance and execution of AI techniques and workloads while maintaining low overhead and complexity.

Additionally, the described systems and methods are not limited to instruction-based processing. Other processing techniques, for example, data-flow-based processing, data-triggered computation and the like, and processors, such as field-programable gate array (FPGA), coarse-grained reconfigurable architecture (CGRA) and data-flow processors can be improved and/or augmented by the described embodiments.

FIG. 2 illustrates an example machine workload computation 26, which can be efficiently executed by employing the described embodiments. Workload 26 can include a structural operation 34, an element-wise vector multiplication, multiplying vector 28 and vector 30 resulting in vector 32. To execute the workload 26, four operations 36, 38, 40 and 42 are performed. In a SIMD/vector machine four ALUs would be deployed to carry out the operations 36, 38, 40 and 42 in parallel. However, operations 36, 38 and 42 include a performance saving data element zero and can be skipped. In other words, the hardware performing the workload 26 may skip executing operations related to carrying out the multiplication operations 36, 38 and 42 because the result is going to be zero. The hardware performing the workload 26 can skip multiplication with zero and their associated lower level operations (e.g., load data element into computational unit's registers and other associated operations).

Hardware accelerators and/or software utilizing intra-structure parallelism can realize performance gains by detecting, predicting and/or otherwise identifying performance saving data elements (e.g., sparsity, multiplication by zero or small numbers, addition with zero, powers of two, etc.) and taking performance saving measures accordingly.

Existing hardware and software can also be retrofitted and/or redesigned using the described embodiments to detect, predict, track and/or otherwise identify performance saving data elements and opportunities and taking performance saving measures. Example processors and/or systems which can benefit from the described methods and systems (e.g., by being augmented with an accelerator according to the described embodiments) are Google® TPU v1, v2, v3 and v4, NVIDIA® Volta GPU tensor core, SIMD/SIMT vector systolic processors and other systems exploiting intra-structure and/or inter-structure parallelism.

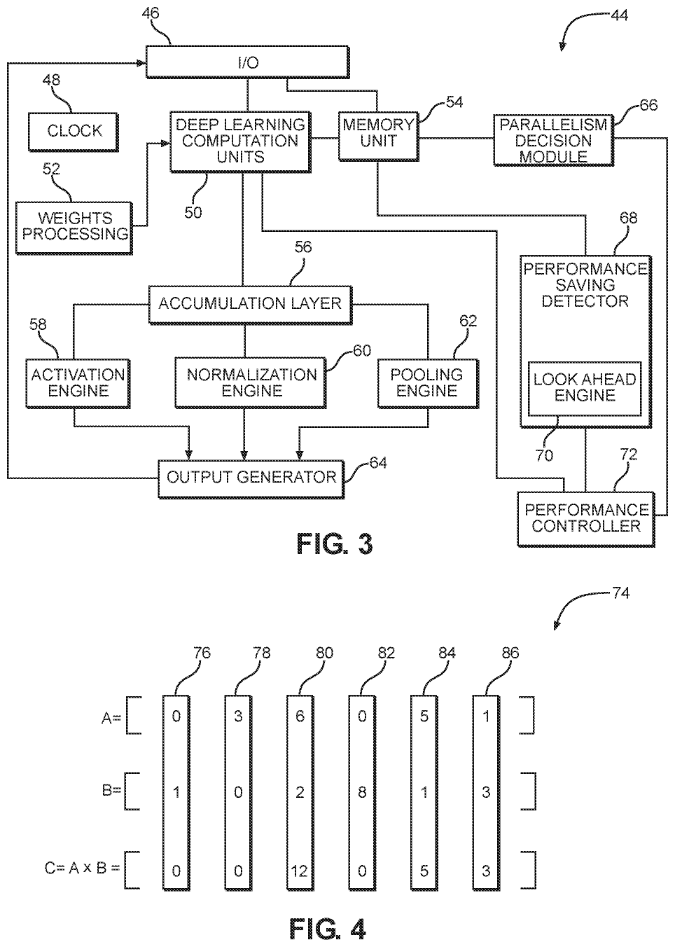

FIG. 3 illustrates a block diagram of a machine learning accelerator 44, which can be used to detect, track, predict or otherwise identify performance saving data elements and take performance saving measures. The accelerator 44 can include an I/O interface 46, a clock signal or clock signal generator 48, a deep learning computation unit 50 (which may include a plurality of deep learning computational units), weights processing engine 52, a memory unit 54 (which may be used for short and/or long term storage needs, such as buffering), an accumulation layer module 56, an activation engine 58, a normalization engine 60, a pooling engine 62, an output generator 64, a parallelism decision module 66, performance saving detector 68, a lookahead engine 70 and performance controller 72.

The components and component layout shown are examples and are for illustrating the described embodiments, fewer or more components directed to machine learning operations can be present. Additionally, some components maybe combined as one component. Some single components may be implemented in two or more additional components.

FIG. 4 illustrates an example machine learning operation workload 74 that can be executed with the embodiment of FIG. 3. The workload 74 includes a six-element vector A being element-wise vector multiplied with a six-element vector B, generating the six-element vector C. Six multiplication operations 76, 78, 80, 82, 84 and 86 are performed in workload 74 to generate the vector C.

In some embodiments, a structural operation (e.g., the multiplication of workload 74) can be performed iteratively upon the data structures of a machine learning workload. Iteration in this context can refer to performing a set of instructions, computer programs, code blocks and/or structures related to the structural operation upon data structures and/or data elements of a machine learning workload in a sequence until the structural operation is performed on a desired number (e.g., all) of the underlying data elements or data structures of the workload. For example, in the workload 74, the program instructions associated with structural operation of multiplication can be performed iteratively upon the vectors A and B to generate the vector C, one operation at a time, two operations at a time, three operations at a time and so forth until vector-wise multiplication of vectors A and B are completed and vector C is generated. Each iteration can include multiple data elements being processed (e.g., multiplied) in parallel.

In some embodiments, the parallelism decision module 66 can scan the incoming workload 74 (e.g., from the memory unit 54 or from I/O 46) to determine an appropriate degree of parallelism in execution independent of the degree of parallelism in the workload 74 in order to optimize the resources of the deep learning computation units 50. For example, while a high degree of parallelism may exist in a machine learning workload stored in memory unit 54, the parallelism decision module 66 may choose to execute fewer operations in parallel than the degree of parallelism in the workload allows. The degree of parallelism in the execution can be determined based on a variety of factors including for example, the type of workload 74, the degree of intra-structure parallelism in the workload 74, type of operations to be performed, type of data structures within the workload 74 and other factors. For example, if the workload 74 is of a type that may contain a high degree of performance saving data elements, the parallelism decision module may decide to execute fewer operations in parallel in order for the accelerator 44 to take performance saving measures before parallel execution.

The parallelism decision module 66 can communicate the degree of parallel execution to the performance controller 72. The performance controller 72 can control the deep learning computation units 50 and/or other components of the accelerator 44 to execute a machine learning workload in the degree of parallel execution determined by parallelism decision module 66. In some embodiments, the degree of parallel execution can be a number less than or equal to one degree less than the degree of parallelism in the workload. For example, in workload 74, the degree of parallelism in the workload is six because A, B and C are six-element vectors. The parallelism decision module 66 can determine to execute one operation at a time (i.e., no parallel execution), two operations at a time (i.e., degree of parallel execution is two), three operations at a time (i.e., degree of parallel execution is three), four operations at a time (i.e., degree of parallel execution is four), or five operations at a time (i.e., degree of parallel execution is five) from operations 76, 78, 80, 82, 84 and 86.

Still the performance saving detector 68 can scan future or incoming workloads for performance saving data elements and discard useless operations before they are performed. For example, transistor gates at hardware level can be used to detect an event of multiplying by zero and the operation can be discarded before it is performed and hardware resources are expended. Performance saving detector 68 can utilize a variety of techniques to track and identify performance saving data elements, such as indexing and n bits per element indication bits.

In some embodiments, a lookahead engine 70 can scan future and incoming executions and workload data structures, pre-fetch a number of future values (and/or meta data associated with them) to speed up upcoming executions. For example, the lookahead engine 70 can scan workload 74 in advance using parallel scanning (e.g., in the same degree as the degree of execution as determined by parallelism decision module 66 or another pre-determined or dynamically determined scanning degree). The lookahead engine can determine that operations 80, 84 and 86 are the ones that yield non-zero values and operations 76, 78 and 82 can be discarded and not performed. In some embodiments, the lookahead engine 70 can pre-fetch future values and increase the performance of upcoming workloads. For example, in workload 74, values for operations 80, 84 and 86 can be pre-fetched, later the operations can be performed and the resulting vector C can be constructed with filling in the remaining data elements with zero.

When a structural operation is cast upon a data structure in a workload, the performance controller 72 can cause computing resources of the accelerator 72 (e.g., deep learning computational units 50) to operate iteratively on the data structure in parallel, where the degree of parallel execution is determined by the parallelism decision module 66 as described above. For example, in workload 74, if the degree of parallelism in execution is 0, the performance controller 72 attempts to execute operations 76, 78, 80, 82, 84 and 86 in that order. Upon detecting that the operation 74 is a multiplication by zero, the operation, associated instructions and data are not loaded or performed and zero is outputted as the result of operation 76 in vector C. Next, operation 78 is also discarded and zero is outputted as the result of operation 78 in vector C. Next, operation 80 is performed normally and the result is entered in vector C. Next, operation 82 is discarded and zero is outputted as the result of the operation 82 in vector C. Next, operation 84 is performed normally and the result is entered in vector C. Next, operation 86 is performed normally and the result is entered in vector C.

If the degree of parallel execution is two, then operations 76 and 78 are attempted, but because multiplication by zero is detected, the execution is discarded and zeros are entered in vector C as the result. Next, operations 80 and 82 are attempted and both are performed in parallel because operation 80 entails a normal, non-zero multiplication. Next, operations 84 and 86 are performed in parallel because they too involve non-zero multiplications.

If the degree of parallel execution is three, then operations 76, 78, and 80 are attempted and all are performed in parallel and the results entered in vector C because one operation, operation 80 involves a non-zero multiplication. Similarly, operations 82, 84 and 86 are performed in parallel and the results are entered in vector C.

If the degree of parallel execution is four or five all operations will be attempted and performed.

Performance saving data elements and their associated performance saving measures are not limited to zeros and multiplications by zero. For example, in some embodiments and depending on the machine learning workload inputted to the accelerator 44, other performance saving elements can be detected and performance saving measures applied accordingly. In some embodiments, the performance controller 72 can be pre-configured with performance rules or can dynamically generate them to exploit performance saving data elements. For example, in some embodiments, numbers smaller than a threshold minimum can be treated as zero. Another rule might define outlier values that may be computed in higher precision, while saving computing resources by avoiding computing the majority of non-outlier elements of a data structure with high precision. For example, while performance controller 72 is iteratively performing operations on a data structure, outlier values encountered can be computed in higher precision than other data elements. Therefore, the accelerator 44 can save on computing resources and time by computing the outlier values in high precision, while computing other values in low precision. Another performance rule can target multiplications involving numbers that are powers of two, when such an operation is detected, they may be efficiently handled with shifting register values during multiplication.

Performance rules enable performance controller 72 to treat performance saving data elements differently and thereby realize performance gains.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first, second, other and another and the like may be used solely to distinguish one entity or action from another without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method of parallel execution in a machine learning accelerator comprising:
receiving and/or determining an operation to be cast on a data structure of a machine learning workload;
determining a degree of parallelism in execution, wherein the degree of parallelism in execution is less than the degree of parallelism in the machine learning workload;
scanning data elements of the machine learning workload;
identifying performance saving data elements in the data structure; and
iteratively executing the operation on the data structure, wherein each iteration comprises, executing the operation, in parallel, in the degree of parallelism in execution, on one or more data elements of the data structure if the data elements are not performance saving data elements and applying a performance saving rule if the data elements are performance saving data elements.

2. The method of claim 1 further comprising allocating computation units in a number equal to the degree of parallelism in execution.

3. The method of claim 1, wherein the performance rule is at least partly based on the operation and the value of the performance saving data element.

4. The method of claim 1, wherein the degree of parallelism in the machine learning workload comprises the degree of intra-structure parallelism in the machine learning workload.

5. The method of claim 1, wherein the performance rule comprises skipping the operation for performance saving data elements.

6. The method of claim 1, wherein the performance rule comprises one or more of treating values below a minimum threshold as zero, computing outliers with higher precision than other values, and performing multiplication of values of powers of two by register shifting.

7. The method of claim 1, wherein the performance saving data elements comprise one or more of zeros, small values, powers of two and outliers.

8. The method of claim 1, wherein determining the degree of parallelism in execution is additionally based on one or more of the operation and type of data structure.

9. The method of claim 1, wherein the data structure comprises one or more of vector, matrix, array and tensor.

10. The method of claim 1, wherein identifying performance saving data elements comprise using transistor gates for determining multiplication by zero.

11. The method of claim 1, further comprising pre-fetching non-performance saving data elements before their turn for execution.

12. The method of claim 1, wherein the operation comprises vector element-wise multiplication, vector scalar multiplication, dot product, general matrix multiplication (GEMM), generalized matrix-vector multiplication (GEMV), vector addition, or matrix addition.

13. A deep neural network learning accelerator comprising:
a memory unit configured to receive a deep neural network workload, wherein the workload comprises a data structure and a data structure operation to be cast on the data structure;
a plurality of neural network computation units capable of executing in parallel;
a parallelism decision module, configured to determine a degree of parallelism in execution, wherein the degree of parallelism in execution is less than degree of parallelism in the data structure;
a performance saving detector, configured to identify performance saving data elements in the data structure; and
a performance controller, configured to iteratively execute the operation on the data structure, wherein each iteration comprises, executing the operation in parallel, in the degree of parallelism in execution determined by the parallelism decision module, on one or more data elements of the data structure if the data elements are not performance saving and apply a performance rule to the performance saving data elements.

14. The accelerator of claim 13, wherein the performance rule comprises skipping the operation for the performance saving data elements.

15. The accelerator of claim 13, wherein the degree of parallelism in the data structure comprises the degree of intra-structure parallelism in the data structure.

16. The accelerator of claim 13, wherein the performance saving data elements comprise one or more of zeros, small values, powers of two and outliers.

17. The accelerator of claim 13, wherein the parallelism decision module determines the degree of parallelism in execution additionally based on one or more of type of workload, the operation, and the data structure.

18. The accelerator of claim 13, wherein the performance rule comprises one or more of treating values below a minimum threshold as zero, computing outliers with higher precision than other values, and performing multiplication of values of powers of two by register shifting

19. The accelerator of claim 13 further comprising a lookahead engine configured to scan future values slated for execution and identify performance saving data elements in advance of their execution.

20. The accelerator of claim 19, wherein the lookahead engine is further configured to pre-fetch non-performance saving data elements for execution.
